(19) United States
(12) Patent Application Publication
(10) Pub. No.: US 2009/0160360 A1
(43) Pub. Date: Jun. 25, 2009

(54) APPARATUS AND METHOD FOR CONTROLLING LIGHTING BRIGHTNESS THROUGH PULSE FREQUENCY MODULATION

(75) Inventors: Joon Hyung LIM, Gunpo-si (KR); Myeung Su Kim, Suwon-si (KR); Kyung Hee Hong, Seoul (KR); Yong Il Kwon, Suwon-Si (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., SUWON-SI (KR)

(21) Appl. No.: 12/044,734

(22) Filed: Mar. 7, 2008

(30) Foreign Application Priority Data
Dec. 21, 2007 (KR) 10-2007-0135400

(51) Int. Cl. H05B 41/36

(52) U.S. Cl. 315/294

(57) ABSTRACT

Provided is an apparatus for controlling lighting brightness through PFM, the apparatus including a lighting control unit that generates a control signal for controlling the brightness of a plurality of lightings; a PFM signal generating unit that is controlled by the control signal so as to generate a plurality of PFM signals having a different frequency from each other; and a driving voltage generating unit that composes the generated PFM signals in accordance with a preset combination, thereby generating driving voltages for driving the lightings.

### CROSS-REFERENCE TO RELATED APPLICATIONS

This application claims the benefit of Korean Patent Application No. 10-2007-0135400 filed with the Korea Intellectual Property Office on Dec. 21, 2007, the disclosure of which is incorporated herein by reference.

### BACKGROUND OF THE INVENTION

1. Field of the Invention

The present invention relates to an apparatus and method for controlling lighting brightness through pulse frequency modulation (PFM).

2. Description of the Related Art

In general, lightings serve to brighten a dark place such that people can recognize something. As for the lightings, light emitting diodes (LEDs), fluorescent lamps, incandescent lamps and so on are usually used.

The brightness and color of lightings can be controlled in accordance with the magnitude of a driving voltage. In this case, the duty width of a PWM (Pulse Width Modulation) signal is adjusted to control the brightness and color.

Hereinafter, a conventional apparatus for controlling lighting brightness will be described with reference to FIGS. 1 and 2.

FIG. 1 is a block diagram of a conventional apparatus for controlling lighting brightness. FIG. 2 is a diagram for explaining a process of controlling the duty width of a PWM signal.

As shown in FIG. 1, the conventional apparatus for controlling lighting brightness includes a lighting control unit 110, a PWM signal generating unit 120, a driving voltage generating unit 130, and a lighting unit 140.

The lighting control unit 110 is connected to the PWM signal generating unit 120 and generates a control signal S for controlling the brightness and color of first to nth lightings 140a to 140n provided in the lighting unit 140.

The lighting control unit 110 receives a current flowing in each lighting of the lighting unit 140 and compares the current with a preset reference value. When the received current is smaller than the reference value, the lighting control unit 110 generates a control signal S for increasing the magnitude of a driving voltage Vc. When the received current is larger than the reference value, the lighting control unit 110 generates a control signal S for reducing the magnitude of a driving voltage Vc.

The PWM signal generating unit 120 is composed of first to nth PWM signal generating sections 120a to 120n. The first to nth PWM signal generating sections 120a to 120n are controlled by the control signal S to generate PWM signals P for increasing or reducing the magnitude of the driving voltage Vc.

At this time, when the control signal S is a signal for reducing the magnitude of the driving voltage Vc, the first to nth PWM signal generating sections 120a to 120n reduce the width of a duty-on interval of the PWM signals P and then output the PWM signals P. Further, when the control signal S is a signal for increasing the magnitude of the driving voltage Vc, the first nth PWM signal generating sections 120a to 120n increase the width of the duty-on interval of the PWM signals P and then output the PWM signals P.

Then, the first to nth driving voltage generating sections 130a to 130n of the driving voltage generating unit 130 receive the PWM signals P of which the duty width is controlled and then output driving voltages Vc corresponding to the PWM signals P, thereby controlling the brightness of the first to nth lightings 140a to 140n.

However, the apparatus for controlling lighting brightness has the following problems.

The apparatus generates the PWM signals P with a constant period to drive the first to nth lightings 140a to 140n. At this time, the width of the duty-on interval of the PWM signals P is increased or reduced by the control signal S to control the driving voltages Vc. However, since the PWM signals P have a constant period, a spurious signal is generated.

Further, because of the spurious signal generated when the plurality of lightings 140a to 140n are driven, noise occurs in the apparatus. Then, lighting efficiency decreases.

### SUMMARY OF THE INVENTION

An advantage of the present invention is that it provides an apparatus and method for controlling lighting brightness through PFM, which combines a plurality of PFM signals having a different frequency in accordance with a preset combination so as to output driving voltages with a non-periodic property. Therefore, it is possible to prevent a spurious signal from being generated.

Additional aspects and advantages of the present general inventive concept will be set forth in part in the description which follows and, in part, will be obvious from the description, or may be learned by practice of the general inventive concept.

According to an aspect of the invention, an apparatus for controlling lighting brightness through PFM comprises a lighting control unit that generates a control signal for controlling the brightness of a plurality of lightings; a PFM signal generating unit that is controlled by the control signal so as to generate a plurality of PFM signals having a different frequency from each other; and a driving voltage generating unit that composes the generated PFM signals in accordance with a preset combination, thereby generating driving voltages for driving the lightings.

Preferably, the PFM signal generating unit includes a plurality of PFM signal generating sections of which the number is equal to the number of the lightings. Each of the PFM signal generating sections includes a plurality of PFM signal generating elements which are controlled by the control signal so as to generate a plurality of PFM signals having a different frequency from each other.

Preferably, the driving voltage generating unit includes a plurality of driving voltage generating sections of which the number is equal to the number of the lightings. Each of the driving voltage generating sections combines the plurality of PFM signal, generated from the PFM signal generating sections, in accordance with a preset combination to thereby generate driving voltages with a non-periodic property.

Preferably, the PFM signals are combined in such a manner that when the duty-on interval of any one of the PFM signals ends, the duty-on interval of the next PFM signal begins. Further, the plurality of lightings are LEDs.

According to another aspect of the invention, a method for controlling lighting brightness through PFM comprises the steps of: (a) generating a control signal for controlling the brightness of a plurality of lightings; (b) generating a plurality of PFM signals having a different frequency from each other, in accordance with the control signal; (c) combining the PFM signals in accordance with a preset combination so as to generate driving voltages; and (d) supplying the generated driving voltages to the lightings, thereby adjusting the brightness of the lightings.

In step (c), the PFM signals are combined in such a manner that when the duty-on interval of any one of the PFM signals ends, the duty-on interval of the next PFM signal begins.

Preferably, the driving voltages have a non-periodic property. Further, the plurality of lightings are LEDs.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of a conventional apparatus for controlling lighting brightness;

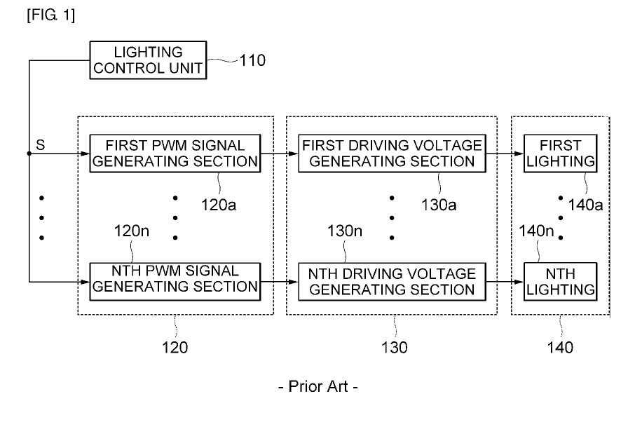

FIG. 2 is a diagram for explaining a process of controlling the duty width of a PWM signal;

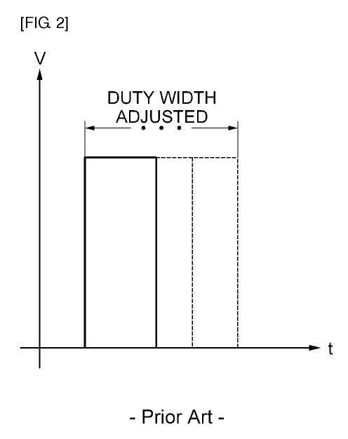

FIG. 3 is a block diagram of an apparatus for controlling lighting brightness through PFM according to the invention;

FIGS. 4A to 4C are diagrams for explaining a process of controlling a PFM signal according to the invention;

FIG. 5 is a block diagram of an apparatus for controlling lighting brightness through PFM according to a modification of the invention; and

FIG. 6 is a flow chart sequentially showing a method for controlling lighting brightness through PFM according to the invention

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, an apparatus and method for controlling lighting brightness through PFM according to the present invention will be described in detail with reference to the accompanying drawings.

Apparatus for Controlling Lighting Brightness

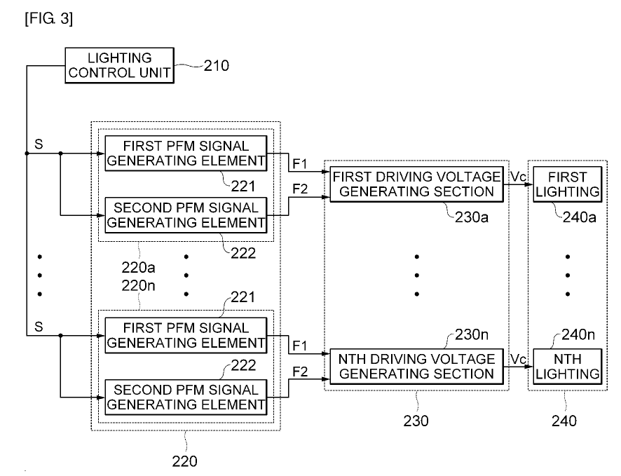

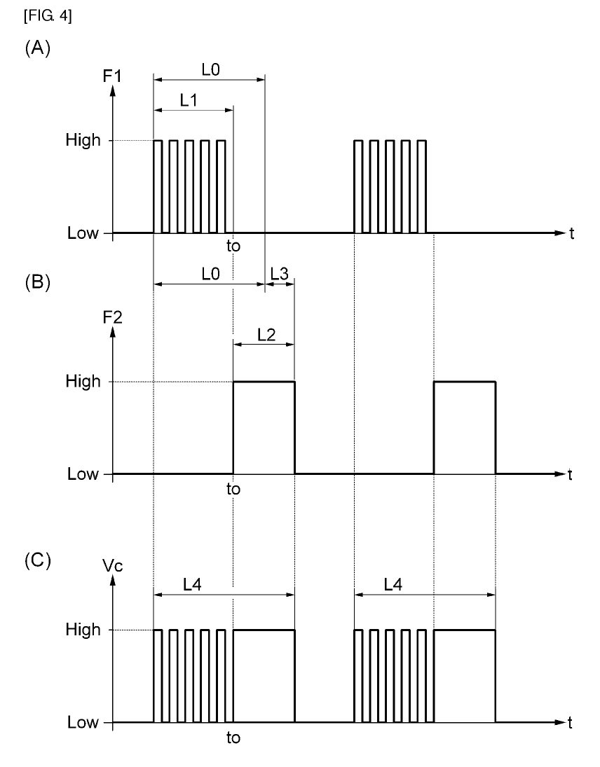

FIG. 3 is a block diagram of an apparatus for controlling lighting brightness through PFM according to the invention. FIGS. 4A to 4C are diagrams for explaining a process of controlling a PFM signal according to the invention.

As shown in FIG. 3, the apparatus for controlling lighting brightness through PFM includes a lighting control unit 210, a PFM signal generating unit 220, and a driving voltage generating unit 230 and controls the brightness and color of a lighting unit 240 composed of first to nth lightings 240a to 240n.

The lighting control unit 210 is connected to the PFM signal generating unit 220 and generates a control signal S for controlling the brightness of the first to nth lightings 240a to 240n provided in the lighting unit 240. Preferably, the first to nth lightings 240a to 240n are LEDs.

The control signal S output from the light control unit 210 includes lighting brightness information for controlling the first to nth lightings 240a to 240n. The lighting brightness information typically indicates information on brightness and color of lighting for RGB and can be classified into 256 stages from 0 to 255.

When the first to nth lightings 250a to 250n are desired to be driven with the brightness and color of the 55th stage, the lighting control unit 210 outputs a control signal S including lighting brightness information corresponding to the 55th stage. When the first to nth lightings 250a to 250n are desired to be driven with the brightness and color of the 234th stage, the lighting control unit 210 outputs a control signal S including lighting brightness information corresponding to the 234th stage.

The PFM signal generating unit 220 is composed of first to nth PFM signal generating sections 220a to 220n of which the number is equal to the number of the first to nth lightings 240a to 240n. The PFM signal generating unit 220 is connected to the lighting control unit 210 and the driving voltage generating unit 230 and receives the control signal S output from the lighting control unit 210 to generate first and second PFM signals F1 and F2 having a different frequency from each other.

Each of the first to nth PFM signal generating sections 220a to 220n is composed of first and second PFM signal generating elements 221 and 222. The first PFM signal generating element 221 is controlled by the control signal S output from the lighting control unit 210 so as to output the first PFM signal F1, and the second PFM signal generating element 222 is also controlled by the control signal S so as to output the second PFM signal F2.

As shown in FIGS. 4A to 4C, the first and second PFM signals F1 and F2 generated from the first and second PFM signal generating units 221 and 222, respectively, have a different frequency from each other. In this case, the duty-on interval L2 of the second PFM signal F2 begins at a point of time t0 when the duty-on interval L1 of the first PFM signal F1 ends.

In particular, the first and second PFM signal generating elements 221 and 222 generate the first and second PFM signals F1 and F2 such that the sum of the duty-on intervals of the first and second PFM signals F1 and F2 corresponds to a duty-on interval L0 preset in accordance with the control signal S delivered from the lighting control unit 210.

The driving voltage generating unit 230 is composed of first to nth driving voltage generating sections 230a to 230n of which the number is equal to the number of the first to nth lightings 240a to 240n. The driving voltage generating unit 230 is connected to the PFM signal generating unit 220 and the lighting unit 240 and combines the first and second PFM signals F1 and F2 delivered by the PFM signal generating unit 220 so as to generate driving voltages Vc for controlling the brightness of the first to nth lightings 240a to 240n. In this case, the first and second PFM signals F1 and F2 are combined in such a manner that the duty-on interval of the second PFM signal F2 begins when the duty-on interval of the first PFM signal F1 ends.

That is, as shown in FIG. 4C, the first and second PFM signals F1 and F2 generated from the first and second PFM signal generating elements 221 and 222 are combined at tO when the duty-on interval of the first PFM signal F1 ends. Then, a driving voltage Vc having a duty-on interval L4 can be generated.

Since the driving voltage Vc is a signal generated by combining the first and second PFM signals F1 and F2 having a different frequency from each other, the driving voltage Vc is a non-periodic signal which does not have a constant period. Therefore, it is possible to prevent a spurious signal from being generated.

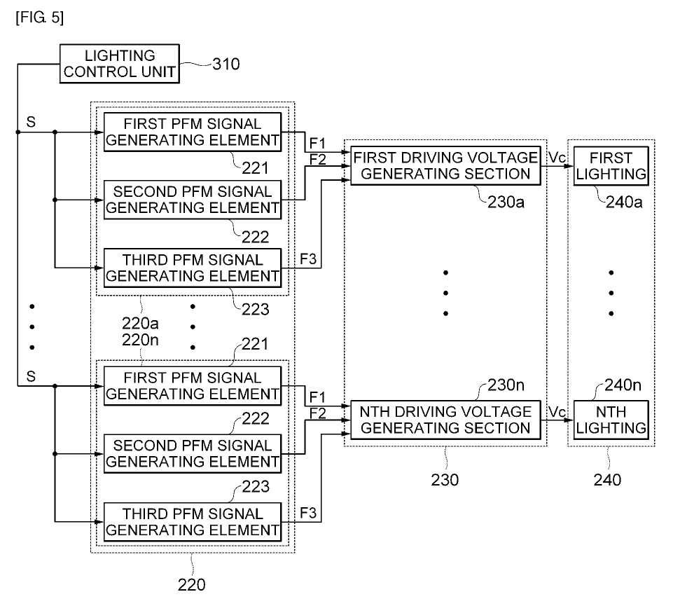

FIG. 5 is a block diagram of an apparatus for controlling lighting brightness through PFM according to a modification of the invention. As shown in FIG. 5, each of the first to nth PFM signal generating sections 220a to 220n may be composed of first to third PFM signal generating elements 221, 222, and 223. Accordingly, the first to nth PFM signal generating sections 220a to 220n generate first to third PFM signals F1 to F3 having a different frequency from one another.

At this time, the first to nth driving voltage generating sections 230a to 230n of the driving voltage generating unit 230 respectively receive the first to third PFM signals F1 to F3 and then compose the first to third PFM signals F1 to F3 such that when the duty-on interval of any one of the first to third PFM signals F1 to F3 ends, the duty-on interval of the next PFM signal begins. Then, it is possible to output driving voltages Vc with a non-periodic property.

Method for Controlling Lighting Brightness

Referring to FIGS. 3, 5, and 6, a method for controlling lighting brightness through PFM according to the invention will be described.

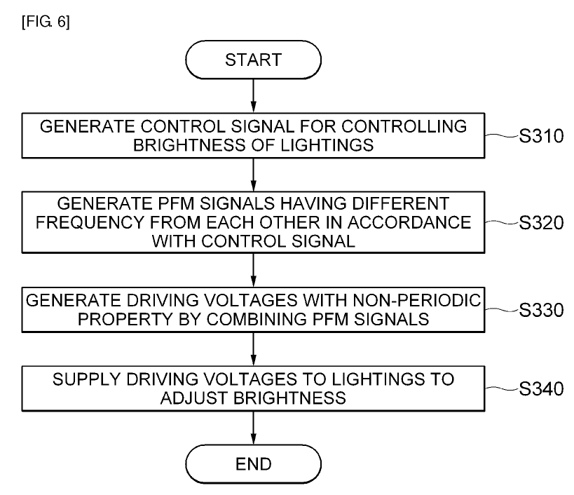

FIG. 6 is a flow chart sequentially showing a method for controlling lighting brightness through PFM according to the invention.

First, as shown in FIG. 6, a control signal S for controlling the brightness and color of the first to nth lightings 240a to 240n is generated (step S310). Preferably, the first to nth lightings 240a to 240n are LEDs.

At this time, the control signal S generated in step S310 includes lighting brightness information for controlling the first to nth lightings 250a to 250n.

Each of the first to nth PFM signal generating sections 220a to 220n is controlled by the control signal S so as to generate first and second PFM signals F1 and F2 having a different frequency from each other (step S320).

Then, the first to nth driving voltage generating sections 230a to 230n respectively receive the first and second PFM signals F1 and F2 to combine in accordance with a preset condition, thereby generating driving voltages Vc with a non-periodic property (step S330).

At this time, the signals are combined in such a manner that the duty-on interval of the second PFM signal begins when the duty-on interval of the first PFM signal F1 ends. As the driving voltages Vc with a non-periodic property are generated by combining the first and second PFM signals F1 and F2 with a periodic property, it is possible to prevent a spurious signal from being generated.

After the driving voltages Vc with a non-periodic property are generated, the driving voltages Vc are supplied to the first to nth lightings 240a to 240n, thereby adjusting the brightness and the color of the lightings.

According to the present invention, a plurality of PFM signals having a different frequency are combined in accordance with a preset combination so as to output driving voltages with a non-periodic property. Therefore, it is possible to prevent a spurious signal from being generated, thereby enhancing the efficiency of the lightings.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus for controlling lighting brightness through pulse frequency modulation (PFM), comprising:
a lighting control unit that generates a control signal for controlling the brightness of a plurality of lightings;
a PFM signal generating unit that is controlled by the control signal so as to generate a plurality of PFM signals having a different frequency from each other; and
a driving voltage generating unit that composes the generated PFM signals in accordance with a preset combination, thereby generating driving voltages for driving the lightings.

2. The apparatus according to claim 1, wherein the PFM signal generating unit includes a plurality of PFM signal generating sections of which the number is equal to the number of the lightings.

3. The apparatus according to claim 2, wherein each of the PFM signal generating sections includes a plurality of PFM signal generating elements which are controlled by the control signal so as to generate a plurality of PFM signals having a different frequency from each other.

4. The apparatus according to claim 3, wherein the driving voltage generating unit includes a plurality of driving voltage generating sections of which the number is equal to the number of the lightings.

5. The apparatus according to claim 4, wherein each of the driving voltage generating sections combines the plurality of PFM signal, generated from the PFM signal generating sections, in accordance with a preset combination to thereby generate driving voltages with a non-periodic property.

6. The apparatus according to claim 5, wherein the PFM signals are combined in such a manner that when the duty-on interval of any one of the PFM signals ends, the duty-on interval of the next PFM signal begins.

7. The apparatus according to claim 1, wherein the plurality of lightings are light emitting diodes (LEDs).

8. A method for controlling lighting brightness through PFM, comprising the steps of:
(a) generating a control signal for controlling the brightness of a plurality of lightings;
(b) generating a plurality of PFM signals having a different frequency from each other, in accordance with the control signal;
(c) combining the PFM signals in accordance with a preset combination so as to generate driving voltages; and
(d) supplying the generated driving voltages to the lightings, thereby adjusting the brightness of the lightings.

9. The method according to claim 8, wherein in step (c), the PFM signals are combined in such a manner that when the duty-on interval of any one of the PFM signals ends, the duty-on interval of the next PFM signal begins.

10. The method according to claim 8, wherein in step (c), the driving voltages have a non-periodic property.

11. The method according to claim 8, wherein the plurality of lightings are LEDs.
